(19) United States
(12) Patent Application Publication
(10) Pub. No.: US 2020/0320998 A1
(43) Pub. Date: Oct. 8, 2020

(54) AGENT DEVICE, METHOD OF CONTROLLING AGENT DEVICE, AND STORAGE MEDIUM

(71) Applicant: HONDA MOTOR CO., LTD., Tokyo (JP)

(72) Inventors: Yoshifumi Wagatsuma, Wako-shi (JP); Yusuke Oi, Tokyo (JP)

(21) Appl. No.: 16/808,438

(22) Filed: Mar. 4, 2020

(30) Foreign Application Priority Data
Mar. 7, 2019 (JP) 2019-041779

(51) Int. Cl. G10L 15/22; G06F 3/16; B60K 35/00

(52) U.S. Cl. CPC G10L 15/22; G06F 3/167; B60K 35/00; B60K 2370/1575; G10L 2015/225; G10L 2015/227; B60K 2370/148; G10L 2015/223

(57) ABSTRACT

An agent device includes a plurality of agent functional units configured to provide a service including causing an output part to output a voice response in accordance with speech of an occupant of a vehicle and a manager configured to activate one agent functional unit corresponding to a first activation phrase that has been spoken among the plurality of agent functional units when the occupant of the vehicle has spoken the first activation phrase individually set for each of the plurality of agent functional units and to activate two or more agent functional units corresponding to a second activation phrase that has been spoken when the occupant of the vehicle has spoken the second activation phrase commonly set for the two or more agent functional units among the plurality of agent functional units.

### CROSS-REFERENCE TO RELATED APPLICATION

Priority is claimed on Japanese Patent Application No. 2019-041779, filed Mar. 7, 2019, the content of which is incorporated herein by reference.

### BACKGROUND

### Field of the Invention

The present invention relates to an agent device, a method of controlling the agent device, and a storage medium.

### Description of Related Art

Conventionally, technology related to an agent function for providing information about driving assistance according to a request of an occupant, control of a vehicle, and other applications while interacting with the occupant of the vehicle has been disclosed (Japanese Unexamined Patent Application, First Publication No. 2006-335231).

### SUMMARY

Although a process in which a vehicle is equipped with a plurality of agent functions has been put into practical use in recent years, a method of activating the agent functions in the case of the process has not been sufficiently studied. Thus, in the conventional technology, an occupant may be required to perform a complicated operation particularly when an activation method is different for each agent function.

The present invention has been made in view of such circumstances, and an objective of the present invention is to provide an agent device, a method of controlling the agent device, and a storage medium capable of improving convenience.

An agent device, a method of controlling the agent device, and a storage medium according to the present invention adopt the following configurations.

(1): According to an aspect of the present invention, there is provided an agent device including: a plurality of agent functional units configured to provide a service including causing an output part to output a voice response in accordance with speech of an occupant of a vehicle; and a manager configured to activate one agent functional unit corresponding to a first activation phrase that has been spoken among the plurality of agent functional units when the occupant of the vehicle has spoken the first activation phrase individually set for each of the plurality of agent functional units and to activate two or more agent functional units corresponding to a second activation phrase that has been spoken when the occupant of the vehicle has spoken the second activation phrase commonly set for the two or more agent functional units among the plurality of agent functional units.

(2): In the above-described aspect (1), the manager activates the plurality of agent functional units when the occupant of the vehicle has spoken the second activation phrase and selects one or more agent functional units whose activation states are continued on the basis of responses from the plurality of agent functional units that have been activated.

(3): In the above-described aspect (1), the manager refers to a group list in which the two or more agent functional units corresponding to the second activation phrase that has been spoken are registered and activates two or more agent functional units selected from among the agent functional units included in the group list that has been referred to.

(4): In the above-described aspect (3), the manager causes a storage to store reference histories of the agent functional units included in the group list and narrows down the number of agent functional units that are activation targets on the basis of the reference histories stored in the storage when two or more agent functional units are activation targets.

(5): In the above-described aspect (3), the group list is obtained by classifying the two or more agent functional units in accordance with functions of the agent functional units.

(6): In the above-described aspect (3), the group list is obtained by classifying the two or more agent functional units in accordance with account information of the occupant of the vehicle.

(7): In the above-described aspect (1), the manager causes a display to display images associated with the two or more agent functional units corresponding to the second activation phrase that has been spoken and receives selection of an agent functional unit whose activation state is continued among the agent functional units that have been displayed from the occupant of the vehicle.

(8): According to another aspect of the present invention, there is provided a method of controlling an agent device, the method including: causing, by a computer, one of a plurality of agent functional units to be activated; providing, by the computer, a service including causing an output part to output a voice response in accordance with speech of an occupant of a vehicle as a function of the agent functional unit that has been activated; activating, by the computer, one agent functional unit corresponding to a first activation phrase that has been spoken among the plurality of agent functional units when the occupant of the vehicle has spoken the first activation phrase individually set for each of the plurality of agent functional units; and activating, by the computer, two or more agent functional units corresponding to a second activation phrase that has been spoken when the occupant of the vehicle has spoken the second activation phrase commonly set for the two or more agent functional units among the plurality of agent functional units.

(9): According to still another aspect of the present invention, there is provided a storage medium storing a program for causing a computer to execute: a process of causing one of a plurality of agent functional units to be activated; a process of providing a service including causing an output part to output a voice response in accordance with speech of an occupant of a vehicle as a function of the agent functional unit that has been activated; a process of activating one agent functional unit corresponding to a first activation phrase that has been spoken among the plurality of agent functional units when the occupant of the vehicle has spoken the first activation phrase individually set for each of the plurality of agent functional units; and a process of activating two or more agent functional units corresponding to a second activation phrase that has been spoken when the occupant of the vehicle has spoken the second activation phrase commonly set for the two or more agent functional units among the plurality of agent functional units.

According to the above-described aspects (1) to (9), it is possible to improve convenience.

### BRIEF DESCRIPTION OF THE DRAWINGS

FIG. 1 is a diagram showing a configuration of an agent system including an agent device.

FIG. 2 is a diagram showing a configuration of an agent device and equipment mounted in a vehicle according to a first embodiment.

FIG. 3 is a diagram showing an example of an arrangement of a display and operation device.

FIG. 4 is a diagram showing an example of list information of activation phrases set for each agent.

FIG. 5 is a diagram showing a configuration of an agent server and a part of a configuration of the agent device.

FIG. 6 is a flowchart for describing a flow of a series of processing steps of the agent device according to the first embodiment.

FIG. 7 is a diagram for describing an operation of the agent device according to the first embodiment.

FIG. 8 is a diagram showing a configuration of an agent device and equipment mounted in a vehicle according to a second embodiment.

FIG. 9 is a diagram showing an example of list information of agents corresponding to activation phrases.

FIG. 10 is a diagram showing an example of a group list classified in accordance with the function of the agent.

FIG. 11 is a diagram for describing an example of a process when a target agent whose activation state is continued is selected.

FIG. 12 is a diagram for describing an example of a process when a target agent whose activation state is continued is selected.

FIG. 13 is a diagram for describing a flow of a series of processing steps of the agent device according to the second embodiment.

FIG. 14 is a diagram for describing the operation of the agent device according to the second embodiment.

FIG. 15 is a diagram showing an example of list information of agents corresponding to activation phrases.

FIG. 16 is a diagram for describing a flow of a series of processing steps of an agent device according to a third embodiment.

### DESCRIPTION OF EMBODIMENTS

Hereinafter, an embodiment of an agent device, a method of controlling the agent device, and a storage medium according to the present invention will be described with reference to the drawings. The agent device is a device for implementing a part or all of an agent system. Hereinafter, an agent device mounted in a vehicle (hereinafter referred to as a vehicle M) and having a plurality of types of agent functions will be described as an example of the agent device. The agent function is, for example, a function of providing various types of information based on a request (a command) included in speech of an occupant while interacting with the occupant of the vehicle M and mediating a network service. A plurality of types of agents may have different functions to be performed, different processing procedures, different control, and different output modes and details. The agent functions may include a function of controlling equipment within the vehicle (for example, equipment related to driving control and vehicle body control) and the like.

In addition to, for example, a voice recognition function for recognizing the occupant's voice (a function for converting voice into text), the agent functions are implemented by generally employing a natural language processing function (a function of understanding the structure and meaning of text), an interaction management function, a network search function of searching for another device via a network or a predetermined database on the same device, and the like. Some or all of these functions may be implemented by artificial intelligence (AI) technology. A part of the configuration in which these functions (particularly, a voice recognition function and a natural language processing/interpretation function) are performed may be mounted in an agent server (an external device) capable of communicating with an in-vehicle communication device of the vehicle M or a general-purpose communication device brought into the vehicle M. In the following description, it is assumed that a part of the configuration is mounted in the agent server and the agent device and the agent server cooperate to implement an agent system. A service providing entity (a service entity) that is allowed to virtually appear by the agent device and the agent server in cooperation is referred to as an agent. An entity for providing the agent service may be an entity for providing one or more agents or may be a providing entity that differs for each agent.

### <Overall Configuration>

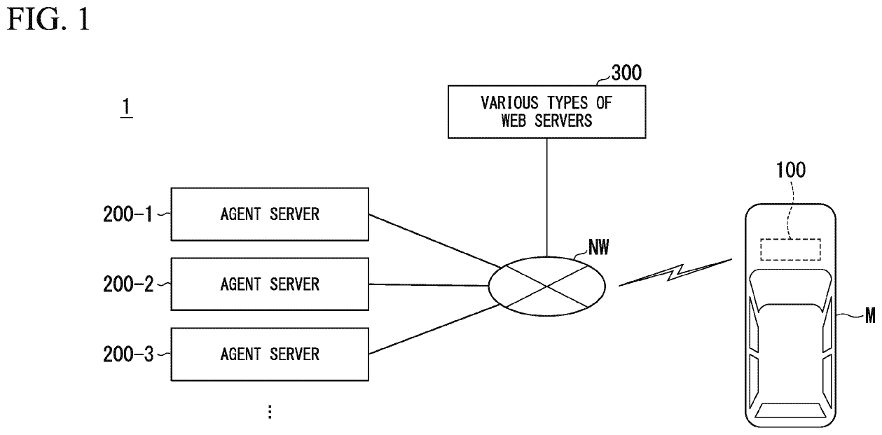

FIG. 1 is a configuration diagram of an agent system 1 including an agent device 100. The agent system 1 includes, for example, an agent device 100 and a plurality of agent servers 200-1, 200-2, 200-3, and the like. A number following the hyphen at the end of the reference sign is an identifier for identifying the agent. When it is not necessary to distinguish between the agent servers, the agent servers may be simply referred to as agent servers 200. Although three agent servers 200 are shown in FIG. 1, the number of agent servers 200 may be two or may be four or more. The agent servers 200 are operated by agent system providers different from each other. Accordingly, the agents in the present invention are agents implemented by providers different from each other. The providers include, for example, an automobile manufacturer, a network service provider, an e-commerce provider, a mobile terminal seller and manufacturer, and the like. Any entity (a corporation, an organization, an individual, or the like) may become a provider of the agent system.

The agent device 100 communicates with the agent server 200 via a network NW. The network NW includes, for example, some or all of the Internet, a cellular network, a Wi-Fi network, a wide area network (WAN), a local area network (LAN), a public circuit, a telephone circuit, a wireless base station, and the like. Various types of web servers 300 are connected to the network NW and the agent server 200 or the agent device 100 can acquire web pages from the various types of web servers 300 via the network NW.

The agent device 100 interacts with the occupant of the vehicle M, transmits voice from the occupant to the agent server 200, and presents a response obtained from the agent server 200 to the occupant in the form of voice output or image display.

### First Embodiment

### [Vehicle]

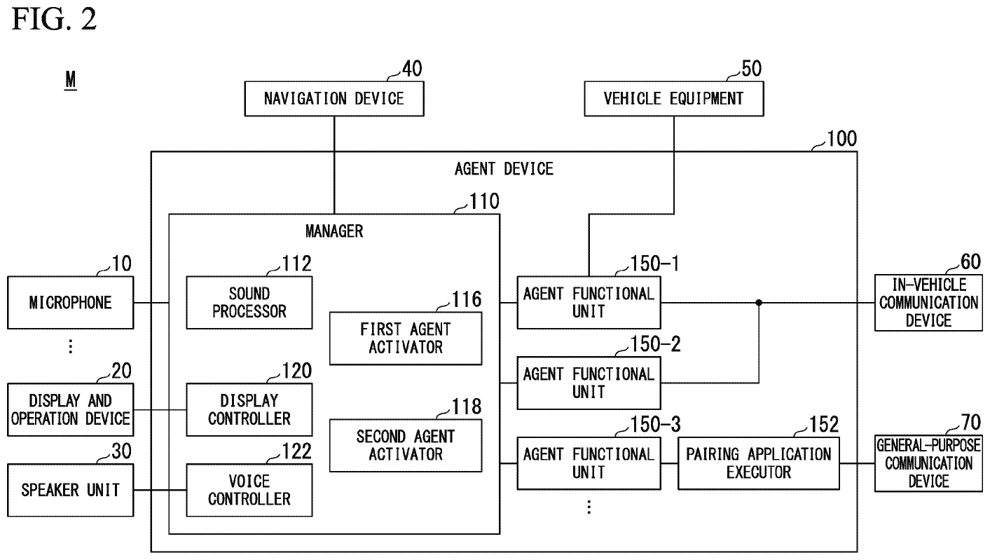

FIG. 2 is a diagram showing a configuration of the agent device 100 and equipment mounted in the vehicle M according to the first embodiment. In the vehicle M, for example, one or more microphones 10, a display and operation device 20 (an example of “display”), a speaker unit 30, a navigation device 40, vehicle equipment 50, an in-vehicle communication device 60, and an agent device 100 are mounted. In some cases, a general-purpose communication device 70 such as a smartphone is brought into the interior of the vehicle and used as a communication device. These devices are mutually connected by a multiplex communication line or a serial communication line such as a controller area network (CAN) communication line, a wireless communication network, or the like. The configuration shown in FIG. 2 is merely an example and parts of the configuration may be omitted or other configurations may be added.

The microphone 10 is a sound collector configured to collect voice emitted in the interior of the vehicle. The display and operation device 20 is a device (or a device group) that can display an image and accept an input operation. The display and operation device 20 includes, for example, a display device configured as a touch panel. The display and operation device 20 may further include a head up display (HUD) or a mechanical input device. The speaker unit 30 includes, for example, a plurality of speakers (sound output units) arranged at different positions in the interior of the vehicle. The display and operation device 20 may be shared by the agent device 100 and the navigation device 40. These will be described in detail below.

The navigation device 40 includes a navigation human machine interface (HMI), a positioning device such as a global positioning system (GPS) device, a storage device storing map information, and a control device (a navigation controller) for searching for a route and the like. Some or all of the microphone 10, the display and operation device 20, and the speaker unit 30 may be used as a navigation HMI. The navigation device 40 searches for a route (a navigation route) for moving from the position of the vehicle M specified by the positioning device to a destination input by the occupant and outputs guidance information using the navigation HMI so that the vehicle M can travel along the route. A route search function may be provided in the navigation server accessible via the network NW. In this case, the navigation device 40 acquires the route from the navigation server and outputs guidance information. The agent device 100 may be constructed on the basis of a navigation controller. In this case, the navigation controller and the agent device 100 are integrally configured on hardware.

The vehicle equipment 50 includes, for example, a driving force output device such as an engine or a travel motor, an engine starting motor, a door lock device, a door opening/closing device, windows, a window opening/closing device, a window opening/closing control device, seats, a seat position control device, a rearview mirror and its angular position control device, lighting devices inside and outside the vehicle and their control device, a wiper or a defogger and its control device, a direction indicator and its control device, an air conditioner, a vehicle information device for information about a travel distance and a tire air pressure and information about the remaining amount of fuel, and the like.

The in-vehicle communication device 60 is a wireless communication device capable of accessing the network NW using, for example, a cellular network or a Wi-Fi network.

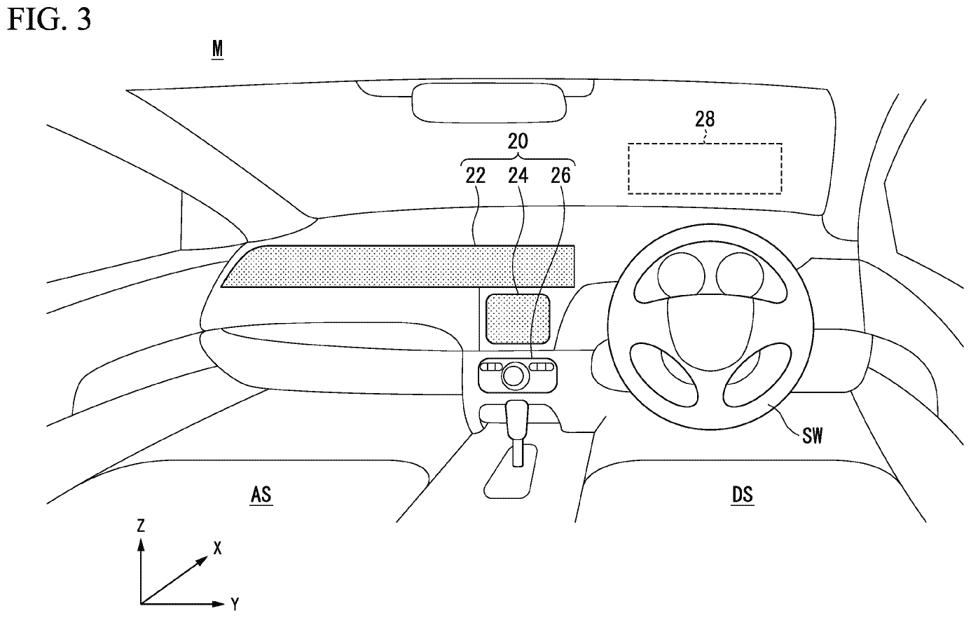

FIG. 3 is a diagram showing an example of the arrangement of the display and operation device 20. The display and operation device 20 includes, for example, a first display 22, a second display 24, and an operation switch ASSY 26. The display and operation device 20 may further include an HUD 28.

The vehicle M includes, for example, a driver seat DS provided with a steering wheel SW and a passenger seat AS provided in a vehicle width direction (a Y-direction in FIG. 3) with respect to the driver seat DS. The first display 22 is a horizontally long display device that extends from around the midpoint between the driver seat DS and the passenger seat AS on an instrument panel to a position facing a left end of the passenger seat AS. The second display 24 is present at an intermediate position between the driver seat DS and the passenger seat AS in the vehicle width direction and is installed below the first display 22. For example, both the first display 22 and the second display 24 are configured as a touch panel and a liquid crystal display (LCD), an organic electroluminescence (EL), a plasma display, or the like is included as the display. The operation switch ASSY 26 has a form in which a dial switch, a button switch, and the like are integrated. The display and operation device 20 outputs details of the operation performed by the occupant to the agent device 100. Details displayed on the first display 22 or the second display 24 may be determined by the agent device 100.

### [Agent Device]

Returning to FIG. 2, the agent device 100 includes a manager 110, agent functional units 150-1, 150-2, and 150-3, and a pairing application executor 152. The manager 110 includes, for example, a sound processor 112, a first agent activator 116, a second agent activator 118, a display controller 120, and a voice controller 122. When it is not necessary to distinguish between the agent functional units, the agent functional units are simply referred to as agent functional units 150. The illustration of the three agent functional units 150 is merely an example corresponding to the number of agent servers 200 in FIG. 1 and the number of agent functional units 150 may be two or may be four or more. A software arrangement shown in FIG. 2 is simply shown for ease of description and can actually be modified arbitrarily, and, for example, the manager 110 may be interposed between the agent functional unit 150 and the in-vehicle communication device 60.

The components of the agent device 100 are implemented, for example, by a hardware processor such as a central processing unit (CPU) executing a program (software). Some or all of these components may be implemented by hardware (a circuit including circuitry) such as large scale integration (LSI), an application specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (the non-transitory storage medium) such as a DVD or a CD-ROM and installed when the storage medium is mounted in a drive device.

The manager 110 functions by executing a program such as an operating system (OS) or middleware.

The sound processor 112 of the manager 110 performs sound processing on the input sound so that the sound processor 112 is in a state suitable for recognizing an activation phrase (a wakeup word) preset for each agent. Activation phrases include, for example, an individual activation phrase and a common activation phrase. The individual activation phrase is individually set for each of the plurality of agent functional units 150. The common activation phrase is commonly set for two or more agent functional units 150 among the plurality of agent functional units 150. The individual activation phrase is an example of a “first activation phrase” and the common activation phrase is an example of a “second activation phrase”.

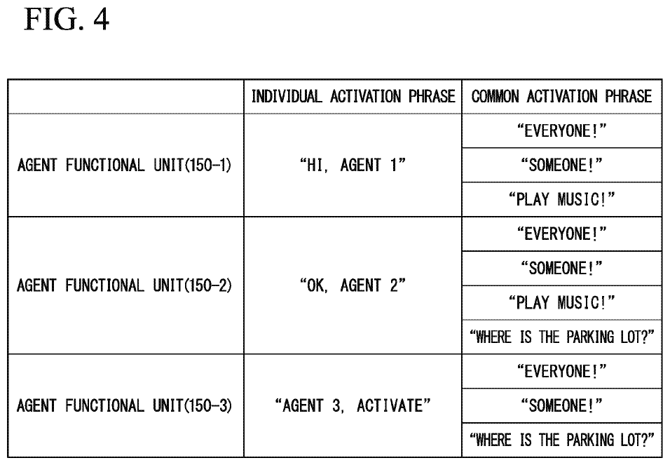

FIG. 4 is a diagram showing an example of list information of the activation phrases set for each of the plurality of agent functional units 150. In the example shown in FIG. 4, “Hi, agent 1” is set as the individual activation phrase corresponding to the agent functional unit 150-1. “OK, agent 2” is set as an individual activation phrase corresponding to the agent functional unit 150-2. “Agent 3, activate” is set as the individual activation phrase corresponding to the agent functional unit 150-3. That is, individual activation phrases different from each other are set one by one with respect to the plurality of agent functional units 150-1, 150-2, and 150-3.

In the example shown in FIG. 4, “Everyone!”, “Someone!”, and “Play music!” are set as common activation phrases corresponding to the agent functional unit 150-1. “Everyone!”, “Someone!”, “Play music!”, and “Where is the parking lot?” are set as common activation phrases corresponding to the agent functional unit 150-2. “Everyone!”, “Someone!”, and “Where is the parking lot?” are set as common activation phrases corresponding to the agent functional unit 150-3. That is, a common activation phrase is set as an activation phrase common to two or more agent functional units among the plurality of agent functional units 150-1, 150-2, and 150-3.

The first agent activator 116 and the second agent activator 118 recognize an activation phrase predetermined for each agent. The first agent activator 116 and the second agent activator 118 recognize the meaning of a sound from voice (a voice stream) subjected to sound processing. First, the first agent activator 116 and the second agent activator 118 detect a voice section on the basis of the amplitude and the zero crossing of a voice waveform in the voice stream. The first agent activator 116 and the second agent activator 118 may perform section detection based on voice identification and non-voice identification in units of frames based on a Gaussian mixture model (GMM).

Next, the first agent activator 116 and the second agent activator 118 convert the voice in the detected voice section into text and generate text information. The first agent activator 116 and the second agent activator 118 determine whether or not the text information corresponds to an activation phrase. When it is determined that the activation phrase is an individual activation phrase, the first agent activator 116 activates the agent functional unit 150 corresponding to the individual activation phrase. When it is determined that the activation phrase is a common activation phrase, the second agent activator 118 activates two or more agent functional units 150 corresponding to the common activation phrase.

For example, the first agent activator 116 determines whether or not the activation phrase is an individual activation phrase and activates the agent functional unit 150-X when it is determined that the activation phrase is an individual activation phrase individually set for the agent functional unit 150-X (X=1, 2, 3).

The second agent activator 118 determines, for example, whether or not the activation phrase is a common activation phrase, and activates two or more agent functional units 150 when it is determined that the activation phrase is a common activation phrase. Each of the two or more agent functional units 150 manages a common activation phrase corresponding thereto and collates the common activation phrase corresponding thereto with information about the common activation phrase acquired from the second agent activator 118. Each agent functional unit 150 outputs a response indicating whether or not the collation has succeeded to the second agent activator 118. The second agent activator 118 specifies the agent functional unit 150 for which the collation has succeeded as the agent functional unit 150 corresponding to the common activation phrase on the basis of the response acquired from each agent functional unit 150. The second agent activator 118 continues an activation state of the agent functional unit 150 corresponding to the common activation phrase. The second agent activator 118 may continue the activation states of two or more agent functional units 150 corresponding to the common activation phrase. The second agent activator 118 may select one of the two or more agent functional units 150 corresponding to the common activation phrase to continue the activation state or may select a plurality of agent functional units 150 to continue the activation state. In this case, for example, the second agent activator 118 may select one or more agent functional units 150 in descending order of priority preset for each agent to continue the activation state or select one or more agent functional units 150 to continue the activation state on the basis of an operation received from the occupant of the vehicle M. The second agent activator 118 stops activation of the agent functional unit 150 that does not correspond to the common activation phrase.

The functions corresponding to the first agent activator 116 and the second agent activator 118 may be mounted in the agent server 200. In this case, the manager 110 transmits a voice stream on which the sound processing has been performed by the sound processor 112 to the agent server 200 and the agent functional unit 150 is activated in accordance with an instruction from the agent server 200 when the agent server 200 determines that the voice stream is the activation phrase. Each agent functional unit 150 may be activated all the time and may determine the activation phrase on its own. In this case, the manager 110 does not need to include the first agent activator 116 and the second agent activator 118.

The agent functional unit 150 causes an agent to appear in cooperation with the corresponding agent server 200 and provides a service including a voice response in response to speech of the occupant of the vehicle. The agent functional units 150 may include an agent functional units 150 to which authority to control the vehicle equipment 50 has been given. The agent functional unit 150 may communicate with the agent server 200 in cooperation with the general-purpose communication device 70 via the pairing application executor 152. For example, the authority to control the vehicle equipment 50 is given to the agent functional unit 150-1. The agent functional unit 150-1 communicates with the agent server 200-1 via the in-vehicle communication device 60. The agent functional unit 150-2 communicates with the agent server 200-2 via the in-vehicle communication device 60. The agent functional unit 150-3 communicates with the agent server 200-3 in cooperation with the general-purpose communication device 70 via the pairing application executor 152. The pairing application executor 152 performs pairing with the general-purpose communication device 70 using, for example, Bluetooth (registered trademark), and causes the agent functional unit 150-3 and the general-purpose communication device 70 to be connected. The agent functional unit 150-3 may be configured to be connected to the general-purpose communication device 70 using wired communication using a universal serial bus (USB) or the like.

The display controller 120 causes the first display 22 or the second display 24 to display an image in accordance with an instruction from the agent functional unit 150. Hereinafter, the first display 22 is assumed to be used. Under the control of the agent functional unit 150, the display controller 120 generates, for example, an image of an anthropomorphized agent that communicates with the occupant in the interior of the vehicle (hereinafter referred to as an agent image) and causes the first display 22 to display the generated agent image. For example, the agent image is an image related to the agent functional unit 150 which is activated. The agent image is, for example, an image in an aspect of talking to the occupant. The agent image may include, for example, at least a face image whose face expression and face direction are recognized by a viewer (an occupant). For example, in the agent image, parts obtained by simulating eyes and a nose of the agent are represented in the face area and the face expression and the face direction may be recognized on the basis of the positions of the parts in the face area. The agent image may be three-dimensionally perceived and the viewer may recognize the agent's face direction by including a head image in a three-dimensional space or recognize the agent's movement, behavior, attitude, and the like by including an image of a main body (a body, hands, and feet) of the agent. The agent image may be an animation image.

The voice controller 122 causes some or all of the speakers included in the speaker unit 30 to output voices in accordance with an instruction from the agent functional unit 150. The voice controller 122 may perform control for causing a sound image of the agent voice to be localized at a position corresponding to the display position of the agent image using the plurality of speaker units 30. The position corresponding to the display position of the agent image is, for example, a position where the occupant is expected to perceive that the agent image is speaking with the agent voice, and is specifically a position near the display position of the agent image. Localizing the sound image includes, for example, determining a spatial position of a sound source to be perceived by the occupant by adjusting a magnitude of the sound to be transferred to left and right ears of the occupant.

### [Agent Server]

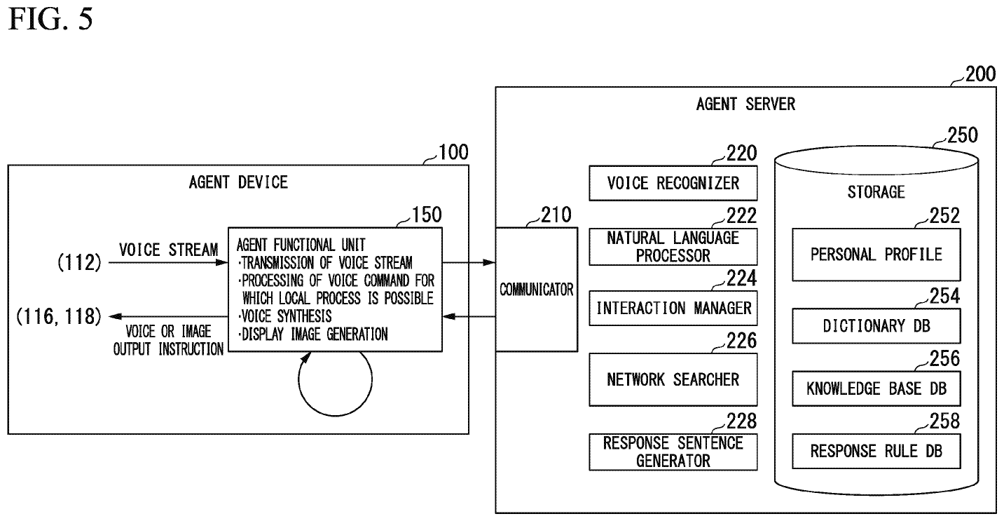

FIG. 5 is a diagram showing the configuration of the agent server 200 and a part of the configuration of the agent device 100. Hereinafter, the operation of the agent functional unit 150 and the like will be described together with the configuration of the agent server 200. Here, the description of physical communication from the agent device 100 to the network NW is omitted.

The agent server 200 includes a communicator 210. For example, the communicator 210 is a network interface such as a network interface card (NIC). Further, the agent server 200 includes, for example, a voice recognizer 220, a natural language processor 222, an interaction manager 224, a network searcher 226, and a response sentence generator 228. These components are implemented, for example, by a hardware processor such as a CPU executing a program (software). Some or all of these components may be implemented by hardware (a circuit including circuitry) such as LSI, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (the non-transitory storage medium) such as a DVD or a CD-ROM and installed when the storage medium is mounted in a drive device.

The agent server 200 includes a storage 250. The storage 250 is implemented by the various storage devices described above. The storage 250 stores data and programs of a personal profile 252, a dictionary database (DB) 254, a knowledge base DB 256, a response rule DB 258, and the like.

In the agent device 100, the agent functional unit 150 transmits a voice stream or a voice stream subjected to a process such as compression or encoding to the agent server 200. When a voice command for which a local process (a process to be performed without involving the agent server 200) is possible has been recognized, the agent functional unit 150 may perform a process requested by the voice command. The voice command for which the local process is possible is a voice command that can be answered by referring to a storage (not shown) included in the agent device 100 or a voice command for controlling the vehicle equipment 50 in the case of the agent functional unit 150-1 (for example, a command for turning on the air conditioner or the like). Accordingly, the agent functional unit 150 may have some of the functions of the agent server 200.

When the voice stream is acquired, the voice recognizer 220 performs voice recognition and outputs text information obtained through conversion into text and the natural language processor 222 performs semantic interpretation on the text information with reference to the dictionary DB 254. The dictionary DB 254 associates abstract meaning information with text information. The dictionary DB 254 may include list information of synonyms. The process of the voice recognizer 220 and the process of the natural language processor 222 are not clearly divided into stages and may be performed while affecting each other such that the voice recognizer 220 corrects a recognition result in response to a processing result of the natural language processor 222.

For example, the natural language processor 222 generates a command replaced with the standard text information “Today's weather” when a meaning such as “How is the weather today?” or “How is the weather?” has been recognized as a recognition result. Thereby, when the voice of the request has text variations, it is also possible to easily perform a requested interaction. For example, the natural language processor 222 may recognize the meaning of the text information using artificial intelligence processing such as a machine learning process using probability or may generate a command based on a recognition result.

The interaction manager 224 determines details of the speech to the occupant of the vehicle M with reference to the personal profile 252, the knowledge base DB 256, or the response rule DB 258 on the basis of a processing result (a command) of the natural language processor 222. The personal profile 252 includes personal information of the occupant, hobbies and preferences, a history of past interactions, and the like stored for each occupant. The knowledge base DB 256 is information that defines relationships between things. The response rule DB 258 is information that defines an operation to be performed by the agent with respect to the command (such as a response or details of equipment control).

The interaction manager 224 may specify the occupant by performing collation with the personal profile 252 using feature information obtained from the voice stream. In this case, in the personal profile 252, for example, personal information is associated with voice feature information. The voice feature information is, for example, information about how someone speaks such as voice pitch, intonation, and rhythm (a voice pitch pattern of the sound) and feature quantities such as mel frequency cepstrum coefficients. The voice feature information is, for example, information obtained by causing the occupant to utter a predetermined word or sentence at the time of initial registration of the occupant and recognizing the uttered voice.

When the command is used to request information capable of being searched for via the network NW, the interaction manager 224 causes the network searcher 226 to search for the information. The network searcher 226 accesses the various types of web servers 300 via the network NW and acquires desired information. The “information capable of being searched for via the network NW” is, for example, an evaluation result of a general user of a restaurant near the vehicle M or a weather forecast according to the position of the vehicle M on that day.

The response sentence generator 228 generates a response sentence so that details of speech determined by the interaction manager 224 are transmitted to the occupant of the vehicle M and transmits the response sentence to the agent device 100. When the occupant is specified to be an occupant registered in the personal profile, the response sentence generator 228 may call the name of the occupant or generate the response sentence in a manner of speaking similar to that of the occupant.

When the response sentence is acquired, the agent functional unit 150 instructs the voice controller 122 to perform voice synthesis and output voice. The agent functional unit 150 instructs the display controller 120 to display an image of the agent according to the voice output. In this manner, an agent function in which a virtually appearing agent responds to the occupant of the vehicle M is implemented.

### [Process Flow of Agent Device]

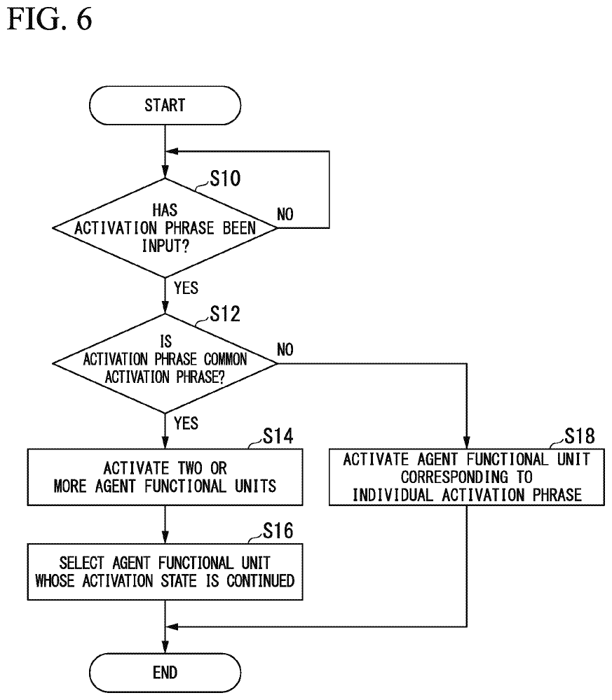

Hereinafter, a flow of a series of processing steps of the agent device 100 according to the first embodiment will be described using a flowchart. FIG. 6 is a flowchart showing a flow of a process of the agent device 100 according to the first embodiment. The process of the present flowchart is started, for example, when the activation of the agent functional unit 150 is stopped.

First, the first agent activator 116 and the second agent activator 118 determine whether or not an occupant of the vehicle M has input an activation phrase (step S10). When it is determined that an activation phrase has been input, the second agent activator 118 determines whether or not the activation phrase is a common activation phrase (step S12). When it is determined that the activation phrase is a common activation phrase, the second agent activator 118 activates two or more agent functional units 150 (step S14). The second agent activator 118 selects, for example, the agent functional unit 150 whose activation state is continued on the basis of a response from the activated agent functional unit 150 (step S16). Thereby, the process of the present flowchart ends. On the other hand, when it is determined that the activation phrase has been input, the first agent activator 116 determines whether or not the activation phrase is an individual activation phrase. When it is determined that the activation phrase is the individual activation phrase, the first agent activator 116 activates the agent functional unit 150 corresponding to the individual activation phrase (step S18). Thereby, the process of the present flowchart ends.

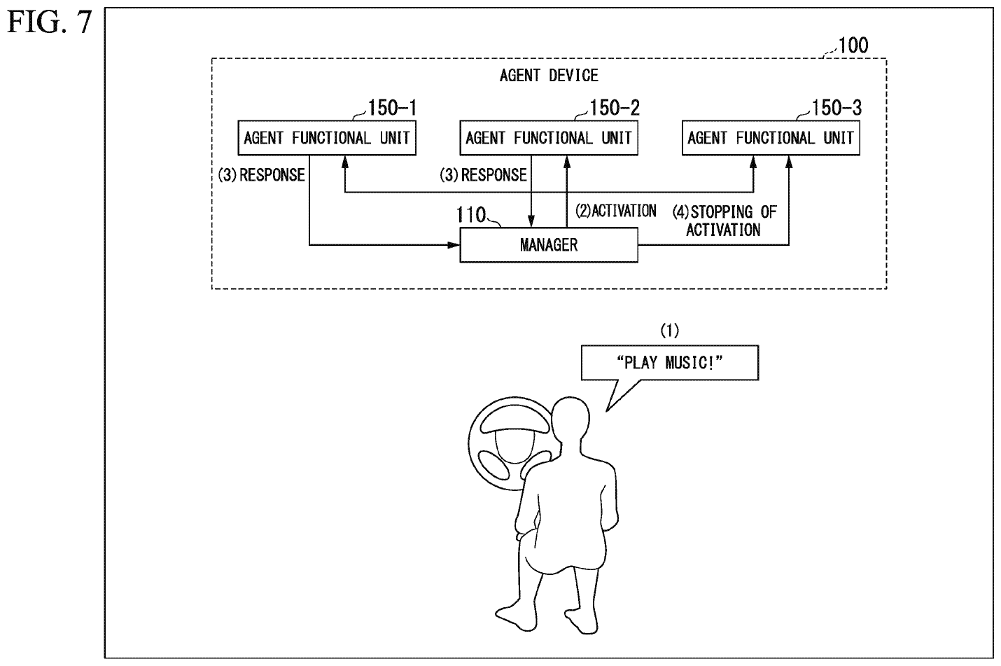

FIG. 7 is a diagram for describing the operation of the agent device 100 according to the first embodiment.

(1) It is assumed that the activation phrase is input from the occupant of the vehicle M to the agent device 100 while the agent functional units 150-1 to 150-3 are stopped. (2) When the activation phrase is a common activation phrase, the manager 110 of the agent device 100 activates two or more agent functional units 150-1 to 150-3. (3) The activated agent functional units 150-1 to 150-3 perform collation with the common activation phrase to which they correspond and responses are output from the agent functional units 150-1 and 150-2 for which collation has succeeded to the manager 110. (4) The manager 110 of the agent device 100 issues an activation stop instruction to the agent functional unit 150-3 from which the response has not been acquired among the agent functional units 150 that have previously been activated. The second agent activator 118 selects the agent functional unit 150 whose activation state is continued, for example, on the basis of a response from the activated agent functional unit 150.

The agent device 100 according to the first embodiment described above can improve convenience. For example, an individual activation phrase is set for each of the plurality of agent functional units 150. In this case, when the agent functional unit 150 is activated, the occupant of the vehicle M needs to know the individual activation phrase corresponding to the agent functional unit 150 to be activated. Thus, particularly when the number of agent functional units 150 to be activated is large, the occupant of the vehicle M needs to perform a complicated operation to activate the agent functional unit 150. On the other hand, in the agent device 100 according to the first embodiment, in addition to the individual activation phrases, a common activation phrase common to two or more agent functional units 150 among the plurality of agent functional units 150 is set. Thus, the occupant of the vehicle M does not necessarily need to know the individual activation phrases corresponding to all the agent functional units 150 to be activated and it is possible to improve the convenience when the agent functional unit 150 is activated.

The agent device 100 according to the first embodiment can further reduce the processing load. For example, when a common activation phrase has been input by an occupant of the vehicle M, the processing load on the agent device 100 increases when two or more agent functional units 150 corresponding to the common activation phrase are activated in parallel. On the other hand, in the agent device 100 according to the embodiment, the processing load on the agent device 100 can be reduced because a target whose activation state is continued is selected from two or more agent functional units 150 corresponding to the common activation phrase when the common activation phrase is input by the occupant of the vehicle M.

### Second Embodiment

Hereinafter, a second embodiment will be described. A process of the second embodiment is different from the process of the first embodiment in that a manager of an agent device specifies an agent functional unit corresponding to a common activation phrase. Hereinafter, the difference will be mainly described.

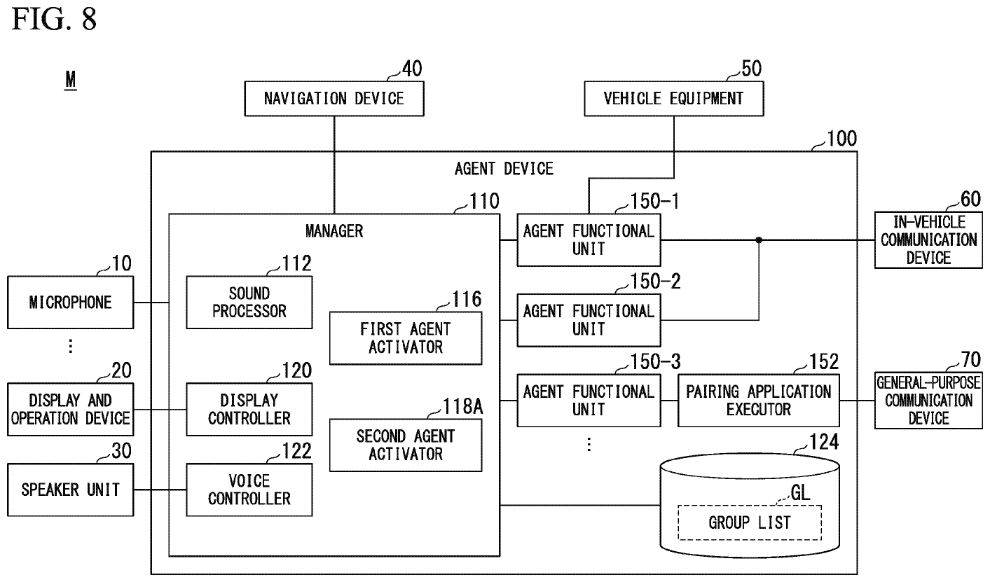

FIG. 8 is a diagram showing a configuration of an agent device 100 and equipment mounted in a vehicle M according to the second embodiment. In the example shown in FIG. 8, a manager 110 of the agent device 100 includes a second agent activator 118A. For example, when it determined that the activation phrase is a common activation phrase, the second agent activator 118A specifies a type of common activation phrase. Then, the second agent activator 118A extracts a keyword from the specified common activation phrase and refers to a group list GL corresponding to the extracted keyword from a storage 124. In the group list GL, two or more agent functional units 150 corresponding to the common activation phrase are registered. The second agent activator 118A activates the agent functional unit 150 registered in the group list GL that has been referred to. The second agent activator 118A may continue the activation states of the two or more agent functional units 150 registered in the group list GL that has been referred to. The second agent activator 118A may select one agent functional unit 150 from the two or more agent functional units 150 registered in the group list GL that has been referred to to continue the activated state or may select a plurality of agent functional units 150 to continue the activation state. In this case, for example, the second agent activator 118A may select one or more agent functional units 150 in descending order of priority preset for each agent functional unit 150 to continue the activation state or may select one or more agent functional units 150 on the basis of an operation of the occupant of the vehicle M to continue the activation state.

The second agent activator 118A stores a reference history of the group list GL in the storage 124. The second agent activator 118A stores the reference history of the group list GL in the storage 124, for example, by adding label information to the group list GL that has been referred to. For example, when two or more agent functional units are activation targets, the second agent activator 118A narrows down the number of agent functional units 150 that are activation targets on the basis of the reference history of the group list GL.

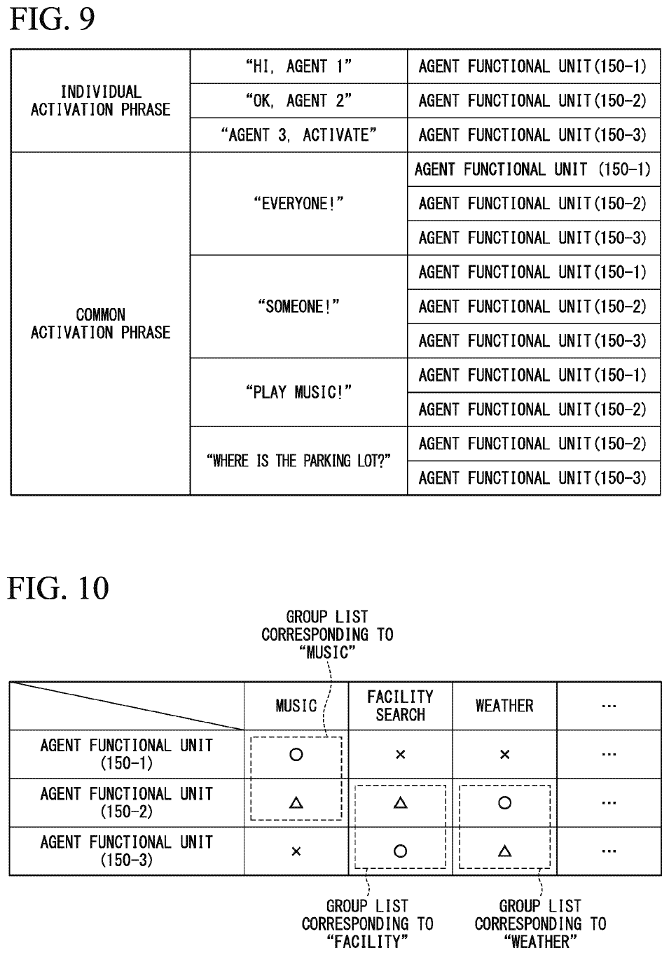

FIG. 9 is a diagram showing an example of list information of the agent functional unit 150 corresponding to the activation phrase. In the example shown in FIG. 9, the agent functional unit 150-1 corresponds to the individual activation phrase “Hi, agent 1”. The agent functional unit 150-2 corresponds to the individual activation phrase “OK, agent 2”. The agent functional unit 150-3 corresponds to the individual activation phrase “Agent 3, activate”. The agent functional unit 150-1, the agent functional unit 150-2, and the agent functional unit 150-3 correspond to the common activation phrases “Everyone!” and “Someone!” The agent functional unit 150-1 and the agent functional unit 150-2 correspond to the common activation phrase “Play music!” The agent functional unit 150-2 and the agent functional unit 150-3 correspond to the common activation phrase “Where is the parking lot?”

FIG. 10 is a diagram showing an example of a group list classified in accordance with the function of the agent functional unit 150. In the example shown in FIG. 10, the agent functional unit 150-1 and the agent functional unit 150-2 having a music playback function are registered in a group list GL corresponding to the keyword “music”. The agent functional unit 150-1 has higher evaluation of the music playback function than the agent functional unit 150-2. In this example, the agent functional unit 150-2 and the agent functional unit 150-3 having the facility search function are registered in the group list GL corresponding to the keyword “facility”. The agent functional unit 150-3 has higher evaluation of the facility search function than the agent functional unit 150-2. In this example, the agent functional unit 150-2 and the agent functional unit 150-3 having a weather information acquisition function are registered in the group list GL corresponding to the keyword “weather”. The agent functional unit 150-2 has higher evaluation of the weather information acquisition function than the agent functional unit 150-3. The evaluations of the functions of the agent functional units 150-1 to 150-3 are determined on the basis of, for example, reference histories of the agent functional units 150-1 to 150-3 stored in the storage 124.

Next, an example of a process in which the second agent activator 118A selects one or more target agent functional units 150 whose activation states are continued from the two or more agent functional units 150 registered in the group list GL will be described.

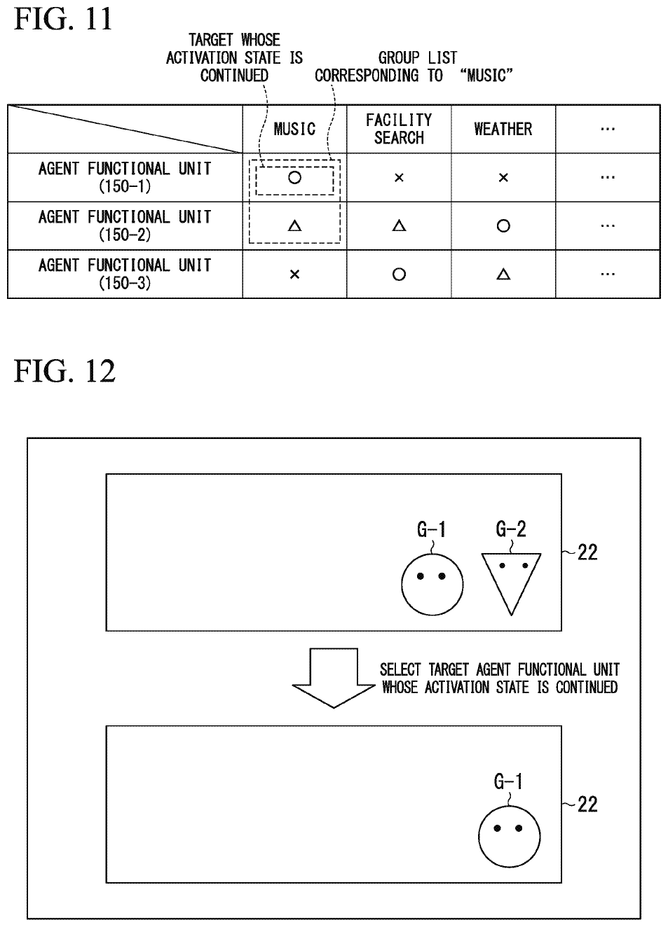

In the example shown in FIG. 11, the second agent activator 118A refers to the group list GL corresponding to the keyword “music”. After the agent functional unit 150-1 and the agent functional unit 150-2 registered in the group list GL are activated, the second agent activator 118A selects the agent functional unit 150-1 having relatively high evaluation of the music playback function as a target whose activation state is continued.

In the example shown in FIG. 12, the second agent activator 118A instructs the display controller 120 to display two agent images G-1 and G-2 corresponding to the agent functional unit 150-1 and the agent functional unit 150-2, respectively, registered in the group list GL on the first display 22. The second agent activator 118A receives the selection of one of the agent functional units 150-1 and 150-2 corresponding to the two agent images G-1 and G-2 displayed on the first display 22 as a target whose activation state is continued through an operation of an occupant of the vehicle M using the first display 22. In this example, the agent functional unit 150-1 is selected as a target whose activation state is continued through the operation of the occupant of the vehicle M. The second agent activator 118A causes the display controller 120 to display only the agent image G-1 corresponding to the agent functional unit 150-1 selected as the target whose activation state is continued on the first display 22.

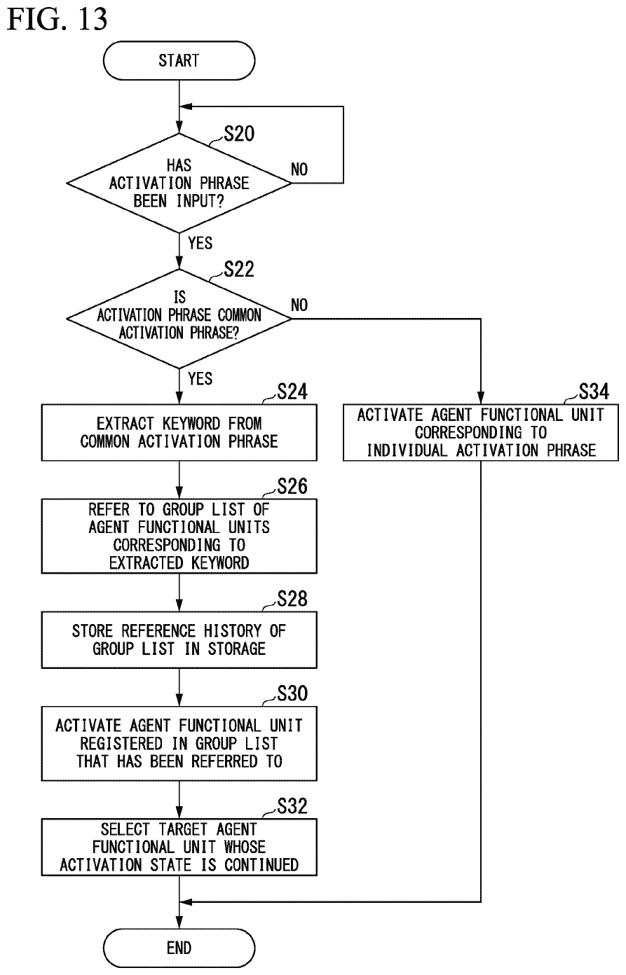

Hereinafter, a flow of a series of processing steps of the agent device 100 according to the second embodiment will be described with reference to a flowchart. FIG. 13 is a flowchart showing a flow of a process of the agent device 100 according to the second embodiment. For example, the process of the present flowchart is started together with the stopping of the activation of the agent functional unit 150.

First, the first agent activator 116 and the second agent activator 118A determine whether or not the occupant of the vehicle M has input an activation phrase (step S20). When it is determined that the activation phrase has been input, the second agent activator 118A determines whether the activation phrase is a common activation phrase (step S22). When it is determined that the activation phrase is the common activation phrase, the second agent activator 118A extracts a keyword from the common activation phrase (step S24). Next, the second agent activator 118A refers to the group list GL of the agent functional unit 150 corresponding to the extracted keyword (step S26). The second agent activator 118A stores a reference history of the group list GL in the storage 124 (step S28). The second agent activator 118A activates the agent functional unit 150 registered in the group list GL that has been referred to (step S30). The second agent activator 118A selects, for example, the target agent functional unit 150 whose activation state is continued on the basis of the evaluation of the function of the agent functional unit 150 (step S32). Thereby, the process of the present flowchart ends. On the other hand, when it is determined that the activation phrase has been input, the first agent activator 116 determines whether or not the activation phrase is an individual activation phrase. When it is determined that the activation phrase is the individual activation phrase, the first agent activator 116 activates the agent functional unit 150 corresponding to the individual activation phrase (step S34). Thus, the process of the present flowchart ends.

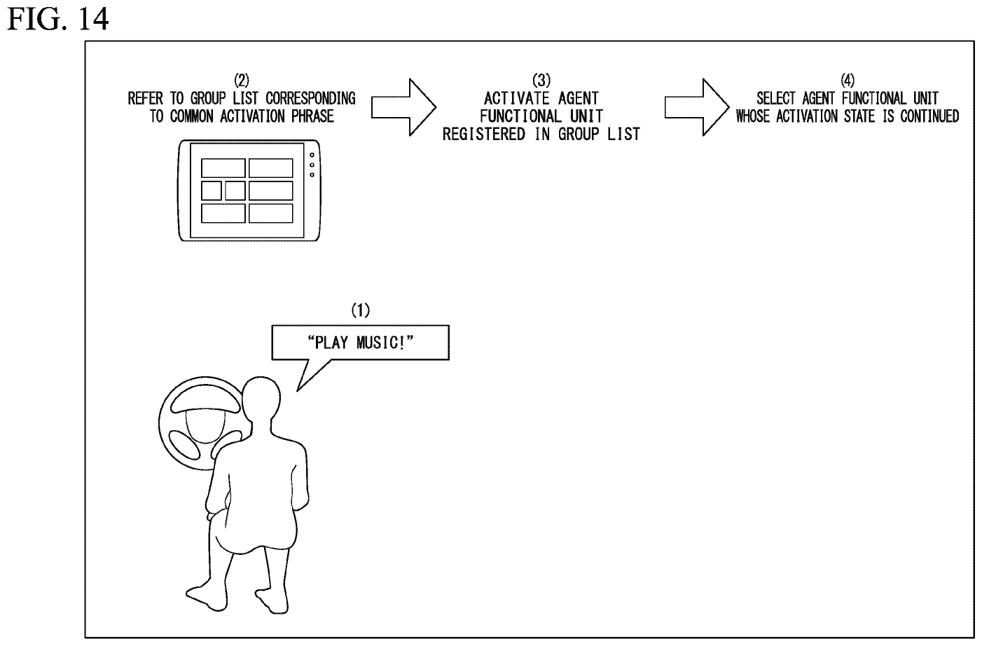

FIG. 14 is a diagram for describing the operation of the agent device 100 according to the second embodiment.

(1) It is assumed that the activation phrase has been input from the occupant of the vehicle M to the agent device 100 while the agent functional unit 150 is stopped. (2) When the activation phrase is a common activation phrase, the manager 110 of the agent device 100 refers to the group list GL corresponding to the common activation phrase. (3) The second agent activator 118A activates the agent functional unit 150 registered in the group list GL. (4) The second agent activator 118A selects the agent functional unit 150 whose activation state is continued, for example, on the basis of the evaluation of the function of the activated agent functional unit 150.

The agent device 100 according to the second embodiment described above can improve convenience as in the agent device 100 according to the first embodiment. The agent device 100 according to the second embodiment can reduce the processing load as in the agent device 100 according to the first embodiment.

The agent device 100 according to the second embodiment can further improve convenience. For example, when a target whose activation state is continued is selected through the operation of the occupant of the vehicle M from two or more agent functional units 150 corresponding to the common activation phrase, the operation for selecting the agent functional unit 150 is complicated. On the other hand, in the agent device 100 according to the second embodiment, a target whose activation state is continued is automatically selected on the basis of the evaluation of the function of the agent functional unit 150 from the two or more agent functional units 150 corresponding to the common activation phrase. Thus, the convenience when the agent functional unit 150 is activated can be further improved.

### Third Embodiment

Hereinafter, a third embodiment will be described. A process of the third embodiment is different from that of the second embodiment in that a manager of an agent device selects a target agent functional unit whose activation state is continued on the basis of account information of the occupant of the vehicle. Hereinafter, the difference will be mainly described.

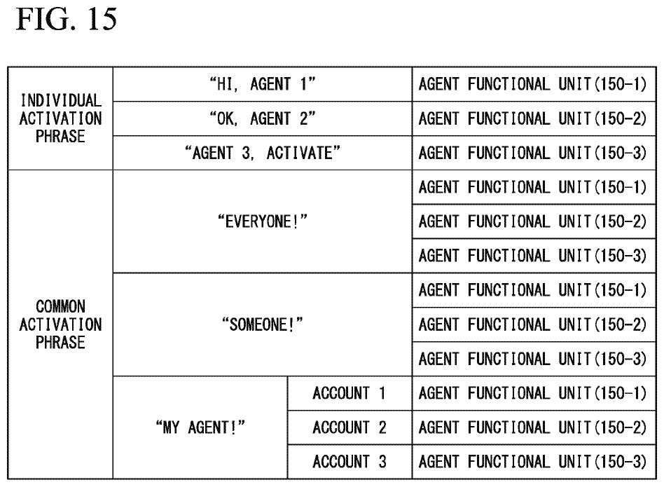

FIG. 15 is a diagram showing an example of an agent functional unit 150 corresponding to an activation phrase. In the example shown in FIG. 15, an agent functional unit 150-1, an agent functional unit 150-2, and an agent functional unit 150-3 correspond to the common activation phrase “My agent!” Each of these agent functional units 150-1, 150-2, and 150-3 is associated with the account information of the occupant of the vehicle M. In this example, the agent functional unit 150-1 is associated with the account information “Account 1”. The agent functional unit 150-2 is associated with the account information “Account 2”. The agent functional unit 150-3 is associated with the account information “Account 3”. That is, the agent functional units 150-1 to 150-3 different from each other are associated with the account information of the occupant of the vehicle M. Although the agent functional units 150 are associated one by one with the account information of the occupant of the vehicle M in this example, a plurality of agent functional units 150 may be associated with the account information of the occupant of the vehicle M.

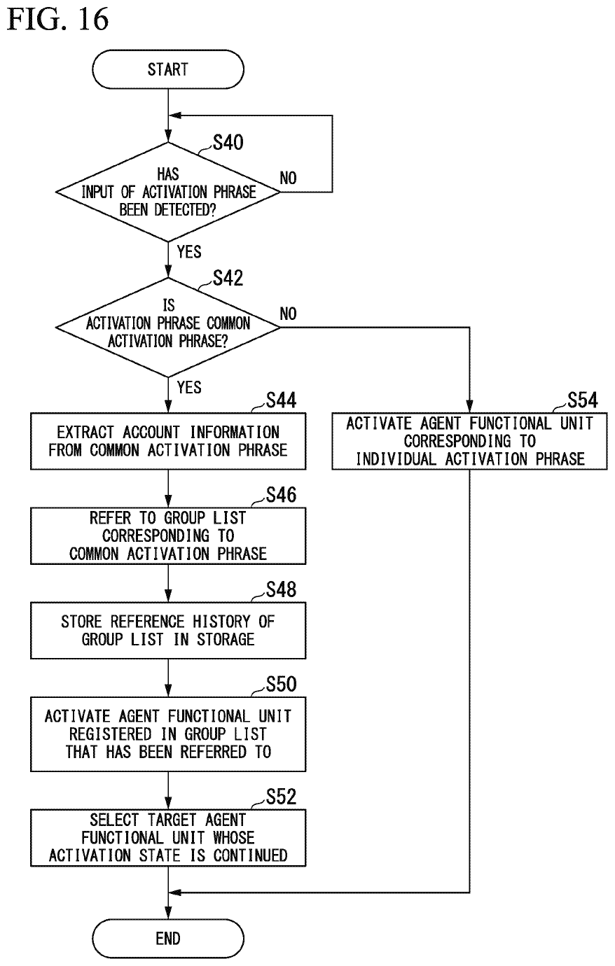

Hereinafter, a flow of a series of processing steps of the agent device 100 according to the third embodiment will be described with reference to a flowchart. FIG. 16 is a flowchart showing the flow of the process of the agent device 100 according to the third embodiment. The process of the present flowchart is started, for example, when the activation of the agent functional unit 150 is stopped.

First, the first agent activator 116 and the second agent activator 118A determine whether or not the occupant of the vehicle M has input an activation phrase (step S40). When it is determined that an activation phrase has been input, the second agent activator 118A determines whether or not the activation phrase is a common activation phrase (step S42). When it is determined that the activation phrase is a common activation phrase, the second agent activator 118A extracts account information from the common activation phrase (step S44). In the example shown in FIG. 15, the second agent activator 118A extracts the keyword “My” from the common activation phrase “My agent!” The second agent activator 118A specifies the driver of the vehicle M through, for example, face authentication or voice authentication, and extracts account information corresponding to the specified driver. Next, the second agent activator 118A refers to a group list GL of the agent functional unit 150 corresponding to the common activation phrase (step S46). The second agent activator 118A stores a reference history of the group list GL in the storage 124 (step S48). The second agent activator 118A activates the agent functional unit 150 registered in the group list GL that has been referred to (step S50). For example, the second agent activator 118A selects the target agent functional unit 150 whose activation state is continued on the basis of the account information of the occupant of the vehicle M (step S52). Thereby, the process of the present flowchart ends. On the other hand, when it is determined that the activation phrase has been input, the first agent activator 116 determines whether or not the activation phrase is an individual activation phrase. When it is determined that the activation phrase is an individual activation phrase, the first agent activator 116 activates the agent functional unit 150 corresponding to the individual activation phrase (step S54). Thus, the process of the present flowchart ends.

The above-described agent device 100 according to the third embodiment can improve convenience as in the agent devices 100 according to the first embodiment and the second embodiment. The agent device 100 according to the third embodiment can reduce the processing load as in the agent devices 100 according to the first embodiment and the second embodiment. The agent device 100 according to the third embodiment can further improve convenience as in the agent device 100 according to the second embodiment.

The agent device 100 according to the third embodiment can provide an agent function suitable for the preference of the occupant of the vehicle. For example, when the vehicle M provides a plurality of types of agent functions, the evaluations of the occupant of the vehicle M with respect to the agent functions are different from each other. On the other hand, in the agent device 100 according to the embodiment, the account information individually corresponding to the occupant of the vehicle M is associated with the two or more agent functional units 150 corresponding to the common activation phrase. Thus, it is possible to provide the agent function suitable for the preference of the occupant of the vehicle M by selecting the agent functional unit 150 whose activation state is continued on the basis of the account information from the two or more agent functional units 150 corresponding to the common activation phrase.

The agent device 100 may be configured by combining the configuration of the first embodiment in which the common activation phrase is registered in the group list GL and the configuration of the second or third embodiment in which the common activation phrase is not registered in the group list GL. In this case, for example, when a common activation phrase registered in the group list GL has been input, the agent device 100 may select the agent functional unit 150 that is an activation target with reference to the group list GL. On the other hand, when a common activation phrase that is not registered in the group list GL has been input, the agent device 100 may activate two or more agent functional units 150 and select an agent functional unit 150 whose activation state is continued on the basis of a response of the activated agent functional unit 150.

Although modes for carrying out the present invention have been described using embodiments, the present invention is not limited to the embodiments, and various modifications and substitutions can also be made without departing from the scope and spirit of the present invention.

What is claimed is:

1. An agent device comprising:
a plurality of agent functional units, each of the agent functional units being configured to provide a service including causing an output part to output a voice response in accordance with speech of an occupant of a vehicle; and
a manager configured to activate one agent functional unit corresponding to a first activation phrase that has been spoken among the plurality of agent functional units when the occupant of the vehicle has spoken the first activation phrase individually set for each of the plurality of agent functional units and to activate two or more agent functional units corresponding to a second activation phrase that has been spoken when the occupant of the vehicle has spoken the second activation phrase commonly set for the two or more agent functional units among the plurality of agent functional units.

2. The agent device according to claim 1,
wherein the manager activates the plurality of agent functional units when the occupant of the vehicle has spoken the second activation phrase and selects one or more agent functional units whose activation states are continued on the basis of responses from the plurality of agent functional units that have been activated.

3. The agent device according to claim 1,
wherein the manager refers to a group list in which the two or more agent functional units corresponding to the second activation phrase that has been spoken are registered and activates two or more agent functional units selected from among the agent functional units included in the group list that has been referred to.

4. The agent device according to claim 3,
wherein the manager causes a storage to store reference histories of the agent functional units included in the group list and narrows down the number of agent functional units that are activation targets on the basis of the reference histories stored in the storage when two or more agent functional units are activation targets.

5. The agent device according to claim 3,
wherein the group list is obtained by classifying the two or more agent functional units in accordance with functions of the agent functional units.

6. The agent device according to claim 3,
wherein the group list is obtained by classifying the two or more agent functional units in accordance with account information of the occupant of the vehicle.

7. The agent device according to claim 1,
wherein the manager causes a display to display images associated with the two or more agent functional units corresponding to the second activation phrase that has been spoken and receives selection of an agent functional unit whose activation state is continued among the agent functional units that have been displayed from the occupant of the vehicle.

8. A method of controlling an agent device, the method comprising:
causing, by a computer, one of a plurality of agent functional units to be activated;
providing, by the computer, a service including causing an output part to output a voice response in accordance with speech of an occupant of a vehicle as a function of the agent functional unit that has been activated;
activating, by the computer, one agent functional unit corresponding to a first activation phrase that has been spoken among the plurality of agent functional units when the occupant of the vehicle has spoken the first activation phrase individually set for each of the plurality of agent functional units; and
activating, by the computer, two or more agent functional units corresponding to a second activation phrase that has been spoken when the occupant of the vehicle has spoken the second activation phrase commonly set for the two or more agent functional units among the plurality of agent functional units.

9. A computer-readable non-transitory storage medium storing a program for causing a computer to execute:
a process of causing one of a plurality of agent functional units to be activated;
a process of providing a service including causing an output part to output a voice response in accordance with speech of an occupant of a vehicle as a function of the agent functional unit that has been activated;
a process of activating one agent functional unit corresponding to a first activation phrase that has been spoken among the plurality of agent functional units when the occupant of the vehicle has spoken the first activation phrase individually set for each of the plurality of agent functional units; and
a process of activating two or more agent functional units corresponding to a second activation phrase that has been spoken when the occupant of the vehicle has spoken the second activation phrase commonly set for the two or more agent functional units among the plurality of agent functional units.
